(19) United States
(12) Patent Application Publication
(10) Pub. No.: US 2025/0328763 A1
(43) Pub. Date: Oct. 23, 2025

(54) ADAPTIVE EXPLAINABILITY FOR MACHINE LEARNING MODELS

(71) Applicant: Verizon Patent and Licensing Inc., Basking Ridge, NJ (US)

(72) Inventors: Satish Seela, Telangana (IN); Gopala K S Narayanan, Tamil Nadu (IN)

(21) Appl. No.: 18/637,499

(22) Filed: Apr. 17, 2024

(51) Int. Cl. G06N 3/082; G06N 3/0455

(52) U.S. Cl. CPC G06N 3/082; G06N 3/0455

(57) ABSTRACT

One or more computing devices, systems, and/or methods for providing adaptive explainability for machine learning models are provided. A knowledge structure, representing entities with nodes and relationships between entities as edges between the nodes, is processed to create knowledge system entity embeddings. A dimensionality of the knowledge system entity embeddings is reduced to create dimensional embeddings. The dimensional embeddings and relationships are processed using an optimal transport plan to generate feedback. The feedback is used to modify the knowledge structure for generating adaptive explainability information that explains predictions generated by the machine learning models.

### BACKGROUND

Many computing environments leverage machine learning models to provide various types of functionality. For example, a machine learning model may be used to predict content that may be interesting to users based upon what content other similar users have consumed. The machine learning model may be used to generate a prediction based upon information stored within domain knowledge. For example, the user may be visiting a website that sells electronics. The machine learning model generates a prediction that the user will have an interest in a particular phone. Accordingly, a recommendation of the phone is displayed through the website to the user.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for providing adaptive explainability for machine learning models, in accordance with an embodiment of the present technology;

FIG. 2 illustrates an example of a system for providing adaptive explainability for machine learning models, in accordance with an embodiment of the present technology;

FIG. 3 is a flow chart illustrating an example method for providing adaptive explainability for machine learning models, in accordance with an embodiment of the present technology;

FIG. 4 illustrates an example of a system for providing adaptive explainability for machine learning models, in accordance with an embodiment of the present technology;

FIG. 5A illustrates an example of a knowledge structure, in accordance with an embodiment of the present technology;

FIG. 5B illustrates an example of a system for providing adaptive explainability for machine learning models, in accordance with an embodiment of the present technology;

FIG. 5C is a flow chart illustrating an example method for estimating a resolution time for a network incident, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

An explainability system is capable of explaining why a machine learning model generated a particular output such as a prediction. The explainability system generates an explanation as to the behavior of the machine learning model. The explanation may be formatted in natural language that can be understood in human terms since complex machine learning models cannot otherwise be fully understood, such as how the inner mechanics impact the output. In an example, a news website may utilize a machine learning model such as a neural network to assign categories to different articles available to publish through the news website. An operator of the news website may find it difficult to understand why the neural network chose particular categorizations for articles in a meaningful way. In order to explain the operation of the neural network, a model agnostic approach can be used to determine that the neural network is assigning a sports category to business articles that mention sports organizations. In this way, explainability refers to the ability to understand and evaluate decisions and reasons underlying predictions output by machine learning models. The ability to better understand the decision-making process enables users to identify biases, errors, and/or limitations in the behavior of a machine learning model in order to improve the operation of the machine learning model. Explainability can be model specific or agnostic (e.g., explaining operation of a particular type of model), and can be task specific or agnostic (e.g., explaining operation of a model that is performing a specific task such as intent detection, named entity recognition, summarization, etc.).

Explaining the behavior of how machine learning models arrive at predictions is a common problem statement in large scale artificial intelligence/machine learning (AI/ML) systems. A significant problem to solve in terms of explainability is how language models (e.g., from conventional task based natural language processing models, to state-of-the-art natural language processing models) arrive at semantic relations between different entities. Explainability is also used to understand how predictive models, based on tabular data, arrive at relations (relationships) between different features and how to explain the importance of those relations between features.

Conventional explainability techniques are limited in that the behavior of a particular machine learning model can only be explained for a particular instance of time. However, the machine learning model may generate different predictions over time for a same or similar set of inputs. For example, a user may visit an electronics website on Monday. A model may be used to generate a prediction. The prediction may be used to create a product recommendation for the user. On Wednesday, the user may return to the electronics website. For the same user, but on a different day, the machine learning model may generate a different prediction that results in a different product recommendation for the user. The machine learning model may have output different predictions resulting in different product recommendations for a variety of different reasons (e.g., a new entity or product became available), which cannot be explained by conventional explainability techniques as they do not account for the changes occurring due to the data and system factors.

One or more systems and/or techniques for providing adaptive explainability for machine learning models are provided. Adaptive explainability provides the ability to explain operation of a model in relation to different context windows corresponding to changes in time, new entities becoming available (e.g., new product becoming available to recommend to users of the electronics website), new relationships amongst entities, etc. The adaptive explainability is capable of accounting for changes in data and system factors in order to provide improve and more accurate explainability. Adaptive explainability is provided as an ongoing and evolving process that involves a feedback loop used to identify and account for changes in time, new entities becoming available, etc.

Adaptive explainability is provided through the implementation of the techniques described herein, which leverages knowledge graph outputs fed into a variational autoencoder followed by an optimal transport plan, according to some embodiments. The knowledge graph is based upon relationships (e.g., relationships established between entities such as terms or words) and embeddings (e.g., embeddings representing entities). The variational autoencoder (e.g., a variational autoencoder based learner) performs low dimensional encoding and reconstruction of embeddings. The optimal transport plan leverages the relationships from the knowledge graph (e.g., existing relationships between entities) and latent representations of the entities and relations learned from the variational autoencoder. In some embodiments, the optimal transport plan provides useful measures of distance between pairs of probability distributions associated with the information within the knowledge graph (e.g., the optimal transport plan may be used to transport between different points within the knowledge graph for measuring distance between the points), which can be output as feedback by the optimal transport plan.

The optimal transport plan provides feedback for the refinement of the original relationships (e.g., creation of new relationships between entities, modifications or removal of existing relationships between entities, etc.). The feedback is generated with context windows that establish new relationships between entities in the knowledge graph (e.g., a relationship between two entities for a particular time window for explaining why a machine learning model generated a prediction during that time window). The feedback is used to perform adaptive explainability that can explain why the model output a prediction for a particular context window. This provides more accurate explainability compared to convention explainability techniques. Adaptive explainability provides users with improved insight into understanding the decision-making process of a machine learning model so that the users can identify biases, errors, and/or limitations in the behavior of the machine learning model. In this way, the users or an automated process may modify the machine learning model to improve the operation of the machine learning model based upon adaptive explainability descriptions.

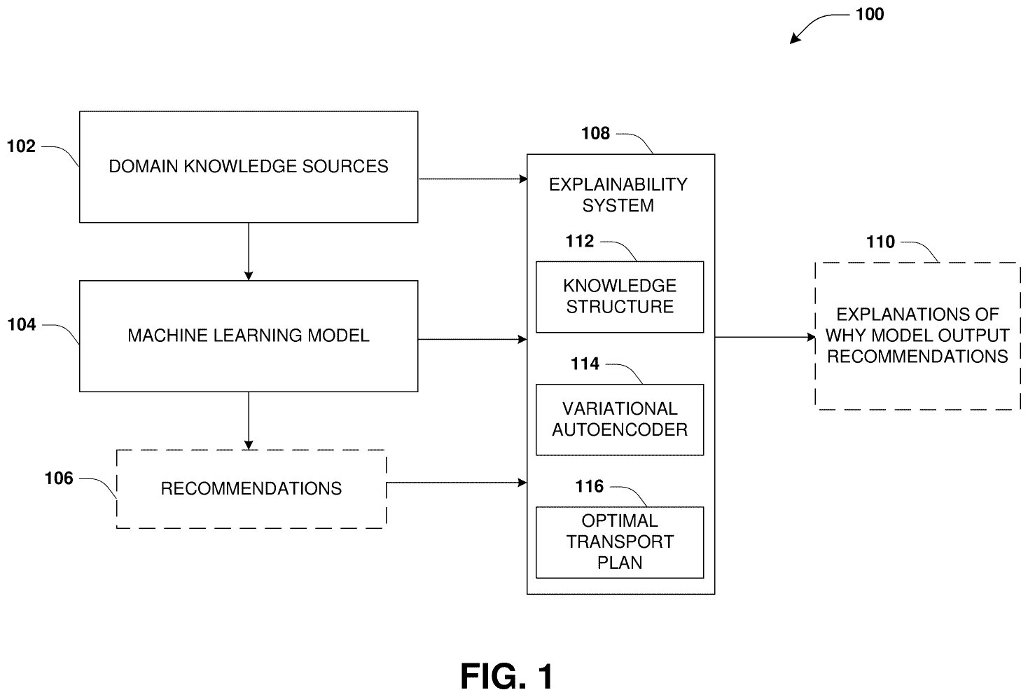

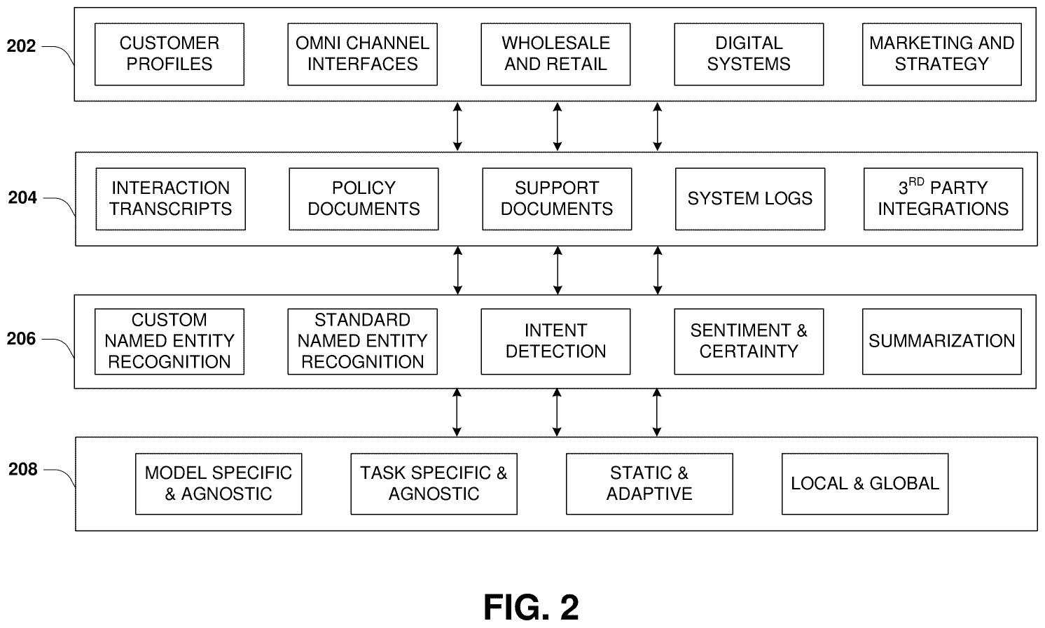

FIG. 1 illustrates an example of a system 100 for providing adaptive explainability for machine learning models, which is described in conjunction with FIG. 2. The system 100 includes an explainability system 108 that is configured to generate explanations of why models (e.g., machine learning/artificial intelligence models) generate certain outputs such as predictions (e.g., a prediction used to generate a recommendation of a product with which a user is predicted to have an interest).

A machine learning model 104 may process information within domain knowledge sources 102 in order to output predictions used to generate recommendations 106. In some embodiments, the domain knowledge sources 102 may relate to domains 202 such as customer profiles, omni channel interfaces, wholesale and retail, digital systems, marketing and strategy, etc., as illustrated by FIG. 2. In some embodiments, the domain knowledge sources 102 may relate to sources 204 such as interaction transcripts (e.g., transcripts of interactions between customer support agents and customers), policy documents, support documents (e.g., troubleshooting documentation, frequently asked questions documentation, etc.), system logs (e.g., logs from base stations, cell towers, and/or network elements of a communication network such as a cellular network), third party integration (e.g., integration of a third party service such as a weather service, a cloud computing environment, etc.), as illustrated by FIG. 2.

The machine learning model 104 may be configured to perform various tasks 206 as part of generating outputs of predictions used to generate the recommendations 106. The tasks 206 performed by the machine learning model 104 may include custom named entity recognition (e.g., identifying names of people, places, things, etc. within text), standard named entity recognition, intent detection (e.g., associating text to a given intent by taking a query as input and associating the query with a target class, such as where a text message indicates an intent to pay a phone bill), sentiment and certainty (e.g., analyzing text for polarity from positive to negative emotions; a certainty related to a confidence of an output by the machine learning model 104; etc.), and summarization (e.g., shortening content such as text, audio, or video into shorter summaries or sound bites), as illustrated by FIG. 2.

The explainability system 108 is configured to provide adaptive explainability descriptions 110 that explain why the machine learning model output a prediction over a particular context window. The explainability system 108 may provide adaptive explainability descriptions 110 based upon various tenets 208 such as model specific and agnostic (e.g., explainability for a particular type of machine learning model), task specific and agnostic (e.g., explainability for a particular type of task such as when doing one of the tasks 206, and then doing a different task), static and adaptive (e.g., provide an explanation that is static for a particular point in time, or which can adapt to changes such as new entities of products becoming available to recommend), local or global (e.g., explainability across various systems), etc., as illustrated by FIG. 2.

As part of generating the adaptive explainability descriptions 110, the explainability system 108 processes a knowledge structure 112 (e.g., a knowledge graph) that represents entities (e.g., terms such as reliability, network, service, provider, unstable, system, stability, traceability, log, or any other term) using nodes. An entity may correspond to information within the domain knowledge sources 102 used by the machine learning model 104 to generate predictions used to create the recommendations 106. Relationship between entities are represented as edges between the nodes (e.g., a relationship between a network entity and a reliable entity). The explainability system 108 processes the knowledge structure 112 to create knowledge system entity embeddings (e.g., vector representations of categorical variables).

The explainability system 108 utilizes a variational autoencoder 114 to reduce dimensionality of the knowledge system's entity embeddings. Reducing the dimensionality of the knowledge system's entity embeddings reduces the amount of data to process, thus reducing processing time and complexity for the explainability system 108 (e.g., a reduction from thousands of dimensions/categories to hundreds of dimensions/categories for significantly reducing computational overhead). The dimensional embeddings correspond to latent representations of entities and relations derived from the knowledge structure 112.

The explainability system 108 utilizes an optimal transport plan 116 to process the dimensional embeddings and the relationships from the knowledge structure 112 to create feedback that may be periodically generated such as whenever the explainability system 108 is executed to explain predictions by a machine learning model. In some embodiments, the feedback may describe new relationships between entities within the knowledge structure 112 if the explainability system 108 identified any new relationships between entities. The new relationships may correspond to context windows (e.g., a new relationship may exist between two entities over a particular time window). The feedback is used to modify/update the knowledge structure for use by the explainability system 108 to generate the adaptive explainability descriptions 110 that can describe why the machine learning model 104 output predictions that lead to the recommendations 106. The adaptive explainability descriptions 110 can account for different context windows (e.g., different time windows) and new relationships and/or entities for those context windows. In this way, the explainability system 108 provides more precise explanations for why the machine learning model 104 output the predictions, which can be used to make adjustments to the machine learning model 104 for improving the predictions.

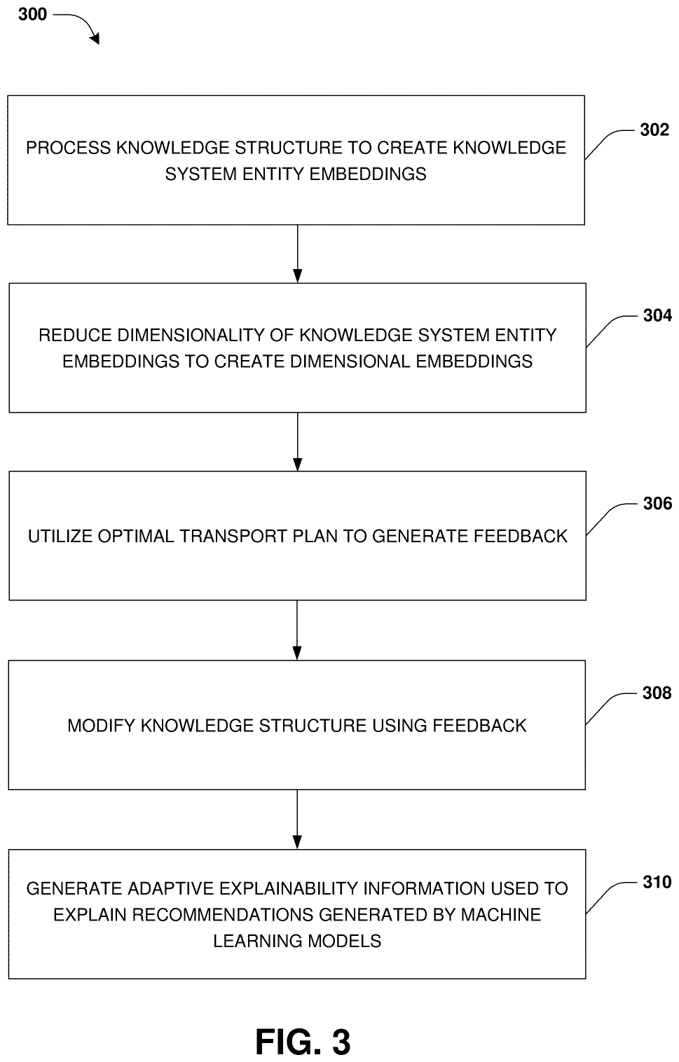

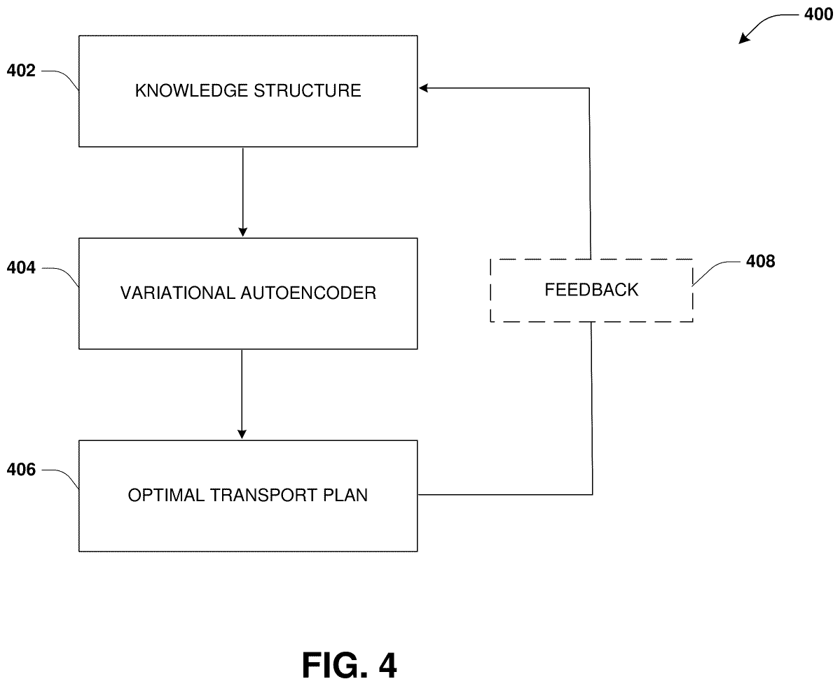

FIG. 3 is a flow chart illustrating an example method 300 for providing adaptive explainability for machine learning models, which is described in conjunction with system 400 of FIG. 4. A knowledge structure 402 (e.g., a graph structure) represents information from domain knowledge sources of different domains, such as the domains 202 and sources 204 previously described in relation to FIG. 2. The knowledge structure 402 represents entities within the knowledge sources (e.g., terms such as “phone,” “tower,” “reception,” etc.) as nodes. Relationships between the entities (e.g., a relationship between “tower” and “reception”) are represented by the knowledge structure 402 as edges between the nodes. In some embodiments, a domain relates to operation of a communication network, such as information maintained by a network provider of a cellular network. An entity relates to information within a domain knowledge source used by a machine learning model to generate an output such as a prediction used to generate a recommendation. During operation 302 of method 300, the knowledge structure 402 is processed to create knowledge system entity embeddings. A knowledge system entity embedding may be created for an entity, and may store values such as within a vector as to how much the entity relates to certain categories (e.g., vehicles, sports, shopping, etc.).

During operation 304 of method 300, a dimensionality of the knowledge system entity embeddings is reduced to create dimensional embeddings (e.g., a reduction from thousands of dimensions/categories to hundreds of dimensions/categories for significantly reducing computational overhead). The knowledge system entity embeddings correspond to latent representations of the entities and relations derived from the knowledge structure 402 (e.g., relationships between entities represented by the knowledge structure 402). In some embodiments, a variational autoencoder 404 or any other dimensionality reduction technique (e.g., Principal Component Analysis, t-Distributed Stochastic Neighbor Embedding, Uniform Manifold Approximation and Projection, Principle Component Analysis, Linear Discriminant Analysis, Canonical Correlation Analysis, Generalized Discriminant Analysis, Non-Negative matrix Factorization, etc.) is executed to reduce the dimensionality of the knowledge system entity embeddings.

During operation 306 of method 300, the dimensional embeddings created by the variational autoencoder 404 (a technique to represent encoded data in a latent space with statistical distribution) and the relationships from the knowledge structure 402 (e.g., relationships amongst entities) are processed by an optimal transport plan (a technique used to capture newly formed relations) 406 to generate feedback 408. The feedback 408 may include context windows for establishing new relationships between entities within the knowledge structure 402 (e.g., a new relationship between a “service” entity and a “disruption” entity over a particular time window). In some embodiments, the optimal transport plan 406 is used to generate a new semantic relationship as the feedback based upon an entity modification that was performed upon the knowledge structure 402 where a new entity became available over a particular context window (e.g., a new entity was added over a particular time window).

During operation 308 of method 300, the knowledge structure 402 is modified using the feedback 408, such as to create new relationships between entities (e.g., create new edges between nodes representing the entities). The knowledge structure 402 is modified using the feedback 408 for generating adaptive explainability information used to explain predictions generated by machine learning models using the information represented by the knowledge structure 402.

During operation 310 of method 300, adaptive explainability information is generated utilizing the knowledge structure 402 modified by the feedback. The adaptive explainability information may include a first adaptive explainability description that explains why a machine learning model output a first prediction over a first context window (e.g., the first context window relating to a first time window where certain entities were available to the machine learning model). The adaptive explainability information may include a second adaptive explainability description that explains why the machine learning model output a second prediction over a second context window (e.g., the second context window relating to a second time window where certain entities were available to the machine learning model). The first and second predictions may be generated for different times (e.g., for different context windows), but for similar inputs (e.g., for a same user visiting a same webpage, but on different days). The feedback 408 may be iteratively generated as a feedback loop for providing adaptive explainability to explain why the machine learning model output different predictions over time for the same or similar inputs.

In some embodiments of techniques for providing adaptive explainability, an embedding is computed for an entity, represented by the knowledge structure 402, based upon weights assigned to other entities within the knowledge structure 402. A weight may correspond to a factor of a distance to the entity by one of the other entities, which may be defined using a Gaussian window function. In this way, weights for an entity with respect to other entities may be generated. The weights may be incorporated into the optimal transport plan 406 to guide a learning process of the variational autoencoder 404 to reduce the dimensionality of the knowledge system entity embeddings. A cost matrix is generated based upon a learned distribution. The learned distribution is generated from the variational autoencoder 404 reducing the dimensionality of the knowledge system entity embeddings. The optimal transport plan 406 is computed based on latent representations of the entities and/or relationships between the entities. An optimal transport loss is computed with a window function based upon cost matrix values and a target distribution over the entities

A context window is defined to capture neighboring entities of an entity. The entities are selected as the neighboring entities in a manner that preserves a context of the entity (e.g., “apple” and “orange” could be neighboring entities in the context of the “apple” being fruit, but selecting “spaceship” as a neighboring entity with “apple” could lose any context of the “apple”). A contextual embedding is calculated for the entity based upon the neighboring entities within the context window. The variational autoencoder 404 is used to map the neighboring entities to latent representations of the neighboring entities within a same latent space as the entity. A mean of the latent representations is calculated to obtain a contextual embedding to the entity.

In some embodiments, an embedding of an entity may be modified to incorporate contextual information from the contextual embedding by adding the contextual embedding to an original embedding of the entity. In some embodiments, an embedding of an entity may be modified to incorporate contextual information from the contextual embedding by using a weighted combination of the contextual embedding and an original embedding of the entity.

The feedback 408 is used to update an embedding for an entity based upon contextual relationships specified by the feedback. The embedding for the entity is updated while preserving an overall meaning and context of the entity. In some embodiments, embeddings for the entities are updated using the feedback 408 to create new embeddings capturing aligned semantic relationships between entities within the knowledge structure 402. In this way, the updated knowledge structure 402 and new embeddings can be used to generate adaptive explainability descriptions for machine learning models.

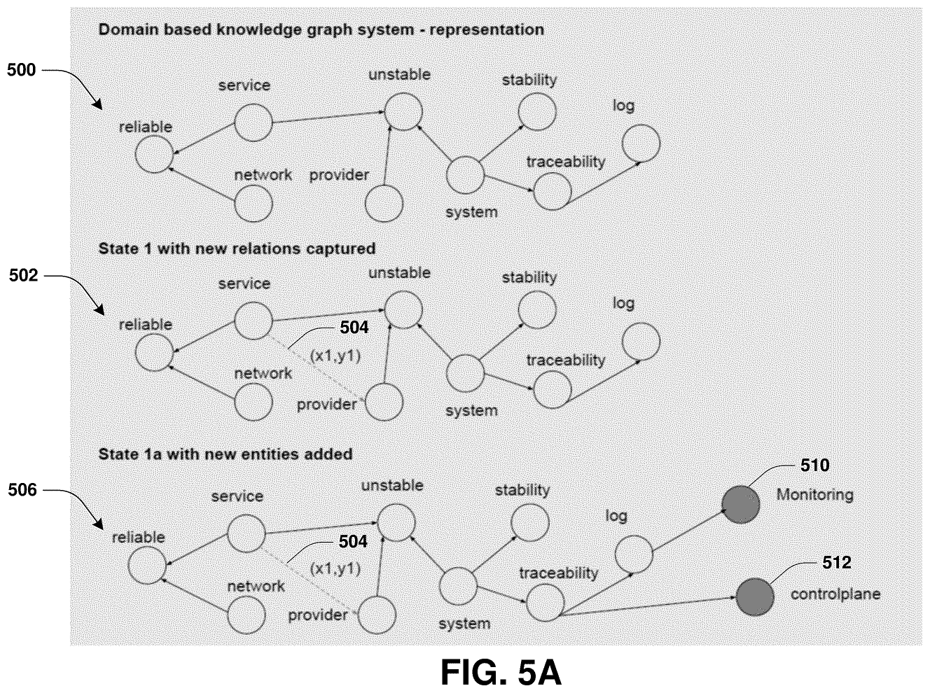

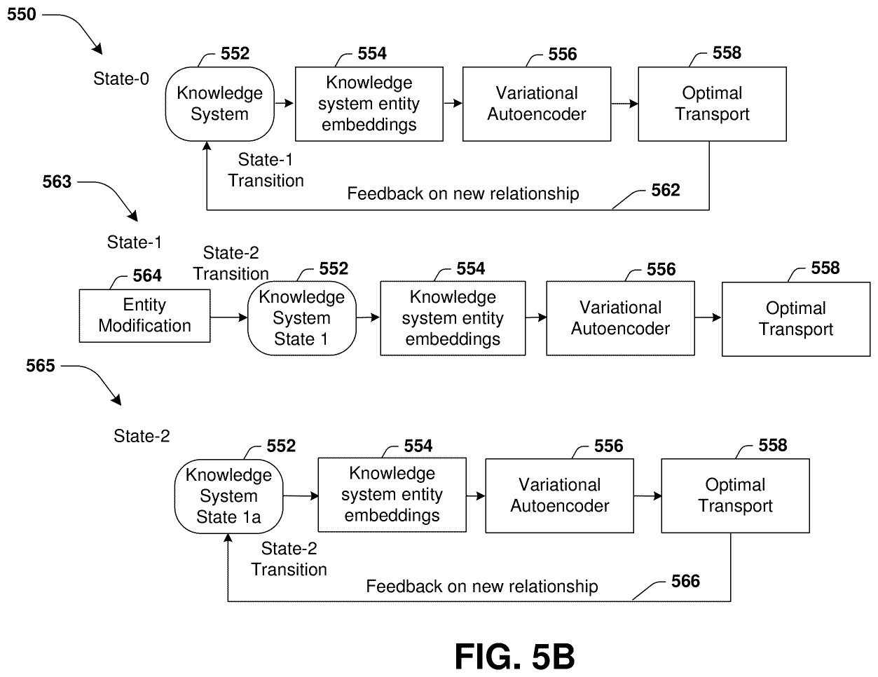

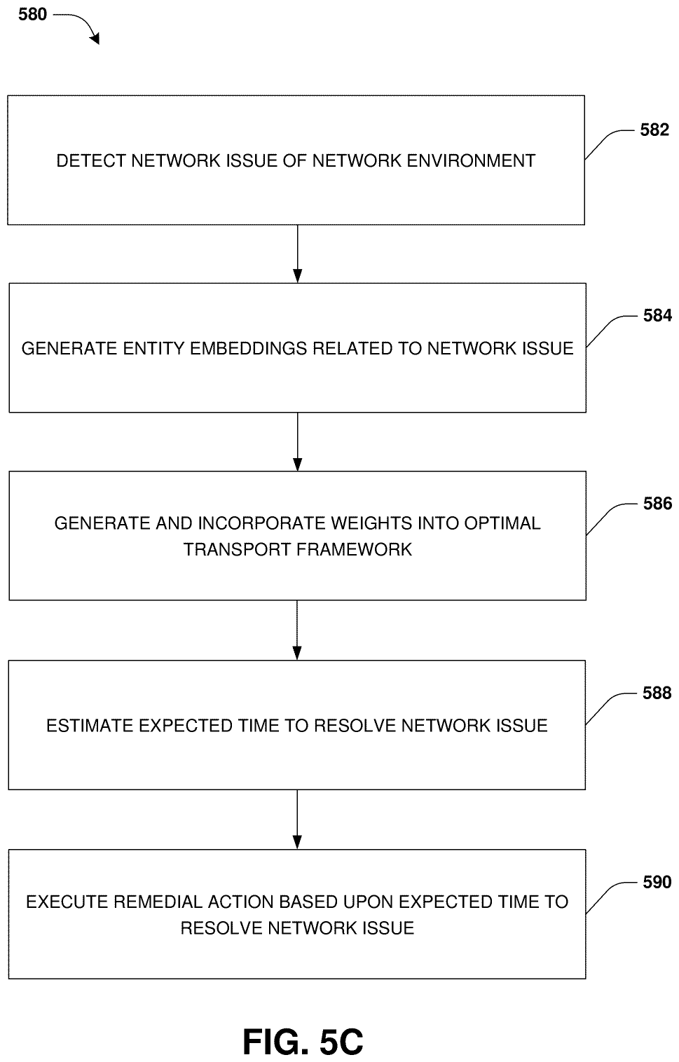

FIG. 5A illustrates an example of a knowledge structure (e.g., a domain-based knowledge graph). An initial knowledge structure 500 includes nodes representing entities, such as a “reliable” entity, a “service” entity, a “network” entity, a “provider” entity, an “unstable” entity, a “system” entity, a “stability” entity, a “traceability” entity, a “log” entity, and/or other entities extracted from domain knowledge sources used by machine learning models to generate outputs such as predictions used to create predictions. The initial knowledge structure 500 is modified to create a first modified knowledge structure 502. For example, feedback from an optimal transport plan is used to add a new relation 504 (a new relationship) corresponding to a new relationship between the “service” entity and the “provider” entity.

The first modified knowledge structure 502 is modified to create a second modified knowledge structure 506. For example, subsequent feedback from the optimal transport plan is used to add a “monitoring” entity 510 and a “controlplane” entity 512 to the first modified knowledge structure 502 to create the second modified knowledge structure 506. In this way, the feedback is iteratively generated for updating/modifying the knowledge graph with new relationships and/or entities for creating adaptive explainability descriptions.

FIG. 5B illustrates an example of a system for providing adaptive explainability for machine learning models. The explainability system 108 may have a state 550 that represents a knowledge system 552 corresponding to a knowledge structure populated with information from domain knowledge sources used by machine learning models to generate predictions. Knowledge system entity embeddings 554 are generated from entities and relationships within the knowledge structure of the knowledge system 552. A variational autoencoder 556 reduces the dimensionality of the knowledge system entity embeddings 554 to create dimensional embeddings. An optimal transport plan 558 processes the dimensional embeddings and relationships from the knowledge system 552 to generate feedback 562. The feedback 562 may be used to modify the knowledge system 552 with new semantic relationships amongst entities.

The explainability system 108 may have a state 563 where an entity modification 564 is performed upon the knowledge system 552 such as to add or remove an entity from the knowledge structure. Knowledge system entity embeddings 554 are generated from entities and relationships within the modified knowledge structure of the knowledge system 552. The variational autoencoder 556 reduces the dimensionality of the knowledge system entity embeddings 554 to create dimensional embeddings. The optimal transport plan 558 processes the dimensional embeddings and relationships from the knowledge system 552 to generate feedback 566 based at least in part upon the entity modification 564, as illustrated by state 565. The feedback 566 may be used to modify the knowledge system 552 with new semantic relationships amongst entities that were modified based upon the entity modification 564.

As a simple example for illustrative purposes, a knowledge graph has three entities: “unstable,” “service,” and “network.” The variational autoencoder will utilize a window function to generate embeddings for the three entities. As an example, the entities are represented as 2-dimensional vectors. The entity embeddings are generated as: unstable: (0.5, 0.3), service: (−0.2, 0.8), and network: (0.9, −0.4). In some embodiments, the computation of the embedding for the entity “unstable” is calculated with a Gaussian window function. Sigma may be set to σ=0.5, which results in a narrow window. The weights assigned to each entity will depend on their distance from “unstable” according to the Gaussian window formula.

The weight of “network” with respect to “unstable” is calculated as: W(unstable, service)=exp(−(−0.7\hat{ }2+0.5\hat{ }2)/2)≈0.7788, where d(service, unstable) represents the Euclidean distance between the embeddings of “service” and “unstable.” Assume sigma σ==1 for this example, computing the weights for the entity “service” with respect to “unstable” includes: W(unstable, service)=exp(−∥unstable−service∥\hat{ }2/(2*sigma\hat{ }2))
=exp(−∥(0.5, 0.3)−(−0.2, 0.8)∥\hat{ }2/(2*1\hat{ }2))
=exp(—∥(0.7, −0.5)∥\hat{ }2/2)
=exp(−0.5\hat{ }2/2)
≈0.7788.

Computing the weights for the entity “network” with respect to “unstable” includes: W(unstable, network)=exp(−∥unstable−network∥\hat{ }2/(2 sigma\hat{ }2))
=exp(−∥(0.5, 0.3)−(0.9, −0.4)∥\hat{ }2/(2*1\hat{ }2))
=exp(−∥(−0.4, 0.7)∥\hat{ }2/2)
=exp(−0.8\hat{ }2/2)
≈0.3263.

Computing the weights for the entity “unstable” with respect to “service” includes: W(service, unstable)=exp(−∥service−unstable∥\hat{ }2/(2*sigma\hat{ }2))
=exp(−∥(−0.2, 0.8)−(0.5, 0.3)∥\hat{ }2/(2*1\hat{ }2))
=exp(−∥(−0.7, 0.5)∥\hat{ }2/2)
=exp(−0.5\hat{ }2/2)
≈0.7788.

Computing the weights for the entity “network” with respect to “service” includes: W(service, network)=exp(−∥service−network∥\hat{ }2/(2*sigma\hat{ }2))
=exp(−∥(−0.2, 0.8)−(0.9, −0.4)∥\hat{ }2/(2*1\hat{ }2))
=exp(−∥(1.1, 1.2)∥\hat{ }2/2)
=exp(−1.53/2)
≈0.5262.

Computing the weights for the entity “unstable” with respect to “network” includes: W(network, unstable)=exp(−∥network−unstable∥\hat{ }2/(2*sigma\hat{ }2))
=exp(−∥(0.9, −0.4)−(0.5, 0.3)∥\hat{ }2/(2*1\hat{ }2))
=exp(−∥(−0.4, −0.7)∥\hat{ }2/2)
=exp(−0.8\hat{ }2/2)
≈0.3263.

Computing the weights for the entity “service” with respect to “network”:
W(network, service)=exp(−∥network−service∥\hat{ }2/(2*sigma\hat{ }2))
=exp(−∥(0.9, −0.4)−(−0.2, 0.8)∥\hat{ }2/(2*1\hat{ }2))
=exp(−∥(1.1, −1.2)∥\hat{ }2/2)
=exp(−1.53/2)
≈0.5262.

Similarly, the weights of the other entities with respect to “unstable” are computed:
W(unstable, network) ≈0.3263.
W(service, unstable) ≈0.7788.
W(service, network) ≈0.5262.
W(network, unstable) ≈0.3263.
W(network, service) ≈0.5262.

These weights can then be incorporated into the optimal transport framework (an optimal transport plan) to guide the learning process of the variational autoencoder. By considering the local context within the specified window, the variational autoencoder learns embeddings that capture both the global semantics and the nearby relationships in the knowledge graph.

Assuming a cost matrix C, the optimal transport plan P is calculated based on the latent representations of the entities or relationships. Considering the target distribution P to be a uniform distribution over the entities: P values: [1/3,1/3,1/3]. Calculating the C values with the learned distribution Q obtained from the variational autoencoder with the entity weights as: [0.25,0.4,0.35]includes:
C=[[∥unstable−unstable∥, ∥unstable−service∥, ∥unstable−network∥],
[∥service−unstable∥, ∥service−service∥, ∥service−network∥],
[∥network−unstable∥, ∥network−service∥, ∥network−network∥]]
C=[[0, 0.5, 0.7],
[0.5, 0, 0.8],
[0.7, 0.8, 0]].

Using the defined window function and the given values for C and P, the optimal transport loss can be computed with a window function:
L_OT=P[service, service]*w(service, service)*C[service, service]+P[service, unstable]*w(service, unstable)*C[service, unstable]+P[service, network]*w(service, network)*C[service, network]+P[network, service]*w(network, service)*C[network, service]+P[network, unstable]*w(network, unstable)*C[network, unstable]+P[network, network]*w(network, network)*C[network, network].

By applying the corresponding values: L_OT=0.57.

The total loss combines the variational autoencoder loss and the optimal transport loss, weighted by hyperparameters. As an example, weights are set as λ_vae=0.7 and λ_ot=0.3. The total loss can be computed as: L_total=λ_vae*(L_rec+L_reg)+λ_ot*L_OT. Here, L_rec is the reconstruction loss, and L_reg is the regularization term from the variational autoencoder training.

Before modification, the entity “network” has an original embedding: network_original=[0.9, −0.4], and the entity embeddings are: unstable: (0.5, 0.3), service: (−0.2, 0.8), and network: (0.9, −0.4)

A contextual window (a context window) is defined to capture the surrounding/neighboring entities or words. This contextual window defines which entities are considered for preserving the context of an entity. For example, a sentence is tokenized as: [“unstable” “service” “network” ]. A window of size 2 may be set, which includes two entities on each side of the target entity. Within this window, consider the neighboring entities: “unstable,” “service.” A contextual embedding is calculated for the entity “network” based on its neighbors within the defined window. The variational autoencoder is used to map the neighboring entities (“unstable”, “service”, “network”) to their latent representations in the same latent space where “network_original” resides.

The weights for the entity “network” with respect to “unstable” as computed as: W(unstable, network)=exp(−∥unstable−network∥\hat{ }2/(2*sigma\hat{ }2))
=exp(−∥(0.5, 0.3)−(0.9, −0.4)∥\hat{ }2/(2*1\hat{ }2))
=exp(−∥(−0.4, 0.7)∥\hat{ }2/2)
=exp(−0.8\hat{ }2/2)
≈0.3263.

The weights for the entity “network” with respect to “service” are computed as: W(service, network)=exp(−∥service−network∥\hat{ }2/(2*sigma\hat{ }2))
=exp(−∥(−0.2, 0.8)−(0.9, −0.4)∥\hat{ }2/(2*1\hat{ }2))
=exp(−∥(1.1, 1.2)∥\hat{ }2/2)
=exp(−1.53/2)
≈0.5262.

The mean of these neighboring latent representations is calculated to obtain the contextual embedding for “network.”

The embedding of the entity “network” is modified to incorporate the contextual information. This can be done in various ways, such as adding the contextual embedding to the original embedding: network_modified=network_original+Contextual_embedding. This results in a modified entity: −network: (−0.3, 0.8).

The weights for the entity “network” with respect to “unstable” are computed as: W(unstable, network)=exp(−∥unstable−network∥\hat{ }2/(2*sigma\hat{ }2))
=exp(−∥(0.5, 0.3)−(−0.3, 0.8)∥\hat{ }2/(2*1\hat{ }2))
=exp(−∥(0.7, −0.5)∥\hat{ }2/2)
=exp(−0.5\hat{ }2/2)
≈0.7788.

The weights for the entity “network” with respect to “service” are computed as: W(service, network)=exp(−∥service−network∥\hat{ }2/(2*sigma\hat{ }2))
=exp(−∥(−0.2, 0.8)−(−0.3, 0.8)∥\hat{ }2/(2*1\hat{ }2))
=exp(−∥(0.1, 1.6)∥\hat{ }2/2)
=exp(−0.5/2)
≈0.7788.

Alternatively, a weighted combination can be used to balance the influence of the original and contextual embeddings. An optimization process is used to update the embedding of “network_modified” such that it minimizes the variational autoencoder loss. The loss function includes the reconstruction loss (measuring how well “network_modified” can be reconstructed) and the regularization term to encourage the modified embedding to be consistent with the distribution in the latent space.

After optimization, the embedding for “network” will be updated to reflect its contextual relationships within the sentence while preserving its overall meaning and context.

The embeddings are updated based on the computed optimal transport plan. The new embeddings capture the aligned semantic relationships between words in the knowledge graph. This iterative process can be repeated to further refine the embeddings and improve the alignment of the knowledge graph. The updated embeddings can then be used for various downstream tasks such as word similarity, word analogy, etc.

By incorporating the window function into the optimal transport loss, the learning process takes into account the contextual information and local neighborhood structure of the knowledge graph, resulting in more meaningful and context-aware embeddings used to generate adaptive explainability descriptions.

In some embodiments, the techniques described herein may be used to estimate the expected time to resolve a network issue such as a network router incident of a network environment, which is described in conjunction with method 580 of FIG. 5C. The expected time to resolve the network issue may be estimated utilizing knowledge graph embeddings via optimal transport and a window function, coupled with variational autoencoders (VAEs) or other dimensionality reduction techniques. The network environment may include various network equipment such as routers, repeaters, access points, switches, etc. A network issue such as an unexpected incident may occur, which could impact network performance of the network environment. For example, the network issue may relate to a detected latency spike. In this way, the network issue of the network environment may be detected, during operation 582 of method 580. In some embodiments, the network issue may be detected based upon network router log entries such as: Log 1: Latency spike detected; Log 2: Unusually high CPU utilization identified; Log 3: Increase in packet loss detected; Log 4: Memory usage spikes observed; Log 5: Network latency starts to decrease gradually; and Log 6: Anomalous traffic patterns observed on ingress interface. The log entry may be processed to generate Incidents (1): {Latency spike, High CPU utilization, Packet loss increase, Memory usage spikes, Latency decrease, Anomalous traffic patterns}, and entity embeddings such as Latency spike: (0.2, 0.5); Memory usage spikes: (−0.1, 0.3); Packet loss increase: (0.8, −0.4); and High CPU utilization: (−0.3, 0.7). In this way, entity embeddings may be generated, during operation 584 of method 580.

A window function is defined to capture relationships between entities within a specified window size. In some embodiments, a Gaussian window function may be used such as: W(x, y)=exp(−∥x−y∥\hat{ }2/(2*sigma\hat{ }2)), where x and y represent two entities, and sigma determines the extent of the window. For this example, sigma=1. Weights may be computed for the entity “memory usage spikes” with respect to the entity “Latency spike” such as where: W(Latency spike, Memory usage spikes)=exp(−∥Latency spike−Memory usage spikes∥\hat{ }2/(2*sigma\hat{ }2))=exp(−∥(0.2, 0.5)−(−0.1, 0.3)∥\hat{ }2/(2*1\hat{ }2))=exp(−∥(0.3, 0.2)∥\hat{ }2/2)=exp(−0.13/2)≈0.9394.

Weights may be computed for the entity “Packet loss increase” with respect to the entity “Latency spike” such as where W(Latency spike, Packet loss increase)=exp(−∥Latency spike−Packet loss increase∥\hat{ }2/(2*sigma\hat{ }2))=exp(−∥(0.2, 0.5)−(0.8, −0.4)∥\hat{ }2/(2*1\hat{ }2))=exp(−∥(0.6, 0.9)∥\hat{ }2/2)=exp(−0.765/2)≈0.5828.

Weights may be computed for the entity “High CPU utilization” with respect to the entity “Latency spike” such as where W(Latency spike, High CPU utilization)=exp(−∥Latency spike−High CPU utilization∥\hat{ }2/(2*sigma\hat{ }2))=exp(−∥(0.2, 0.5)−(−0.3, 0.7)∥\hat{ }2/(2*1\hat{ }2))=exp(−∥(0.5, −0.2)∥\hat{ }2/2)=exp(−0.29/2)≈0.8811.

Weights may be computed for the entity “Latency spike” with respect to the entity “Memory usage spikes” such as where W(Memory usage spikes, Latency spike)=exp(−∥Memory usage spikes−Latency spike∥\hat{ }2/(2*sigma\hat{ }2))=exp(−∥(−0.1, 0.3)−(0.2, 0.5)∥\hat{ }2/(2*1\hat{ }2))=exp(−∥(0.3, −0.2)∥\hat{ }2/2)=exp(−0.13/2)≈0.9394.

Weights may be computed for the entity “Packet loss increase” with respect to the entity “Memory usage spikes” such as where W(Memory usage spikes, Packet loss increase)=exp(−∥Memory usage spikes−Packet loss increase∥\hat{ }2/(2*sigma\hat{ }2))=exp(−∥(−0.1, 0.3)−(0.8, −0.4)∥\hat{ }2/(2*1\hat{ }2))=exp(−∥(0.9, 0.7)∥\hat{ }2/2)=exp(−0.98/2)≈0.5232.

Weights may be computed for the entity “Packet loss increase” with respect to the entity “Memory usage spikes” such as where W(Memory usage spikes, High CPU utilization)=exp(−∥Memory usage spikes−High CPU utilization∥\hat{ }2/(2*sigma\hat{ }2))=exp(−∥(−0.1, 0.3)−(−0.3, 0.7)∥\hat{ }2/(2*1\hat{ }2))=exp(−∥(0.2, −0.4)∥\hat{ }2/2)=exp(−0.08/2)≈0.9640.

These weights may be incorporated into the optimal transport framework in order to guide the learning process of the VAE, during operation 588 of method 580. By considering the local context within the specified window, the VAE learns embeddings that capture both the global semantics and the nearby relationships in the knowledge graph.

In some embodiments of implementing the optimal transport loss with window function where there is a cost matrix C, the optimal transport plan P is calculated based upon the latent representations of the entities or relationships. In some embodiments, the defined window function and value for C and P are used to compute the optimal transport loss with the window function. In some embodiments, a total loss calculation incorporates values such as where the total loss combines a VAE loss and the optimal transport loss, weighted by hyperparameters. For example, the weights are λ_vae=0.7 and λ_ot=03. The total loss can be computed as: L_total=λ_vae*(L_rec+L_reg)+λ_ot*L_OT. L_rec is the reconstruction loss and L_reg is the regularization term from the VAE training.

In some embodiments, interactive refinement is performed to update the embeddings based on the computed optimal transport plan. The new embeddings capture the aligned semantic relationships between words in the knowledge graph. This iterative process can be repeated to further refine the embeddings and improve the alignment of the knowledge graph. The updated embeddings can then be used for various downstream tasks such as word similarity, word analogy, etc. By incorporating the window function into the optimal transport loss, the learning process takes into account the contextual information and local neighborhood structure of the knowledge graph, resulting in more meaningful and context-aware embeddings. This iterative process will help to find the relationship between Packet loss increase and Anomalous traffic patterns and so on which were not captured originally. By analyzing the optimal transport loss, the expected time of resolution for the network issue (e.g., the detected the latency spike) can be estimated based on the established relations, during operation 588 of method 500. Contextual representation of network specific terminologies in error logs can be captured over time and the patterns establish the adaptive explainability for a given recommendation with collection of more data/time.

During operation 590 of method 580, a remedial action may be performed based upon the expected time to resolve the network issue. In some embodiments of performing the remedial action, user equipment (e.g., a laptop, a cellular phone, a smart device, or other computing device) may be rerouted from using network equipment experiencing the network issue to other network equipment during the expected time to resolve the network issue. It may be appreciated that a variety of other remedial actions may be performed such as notifying a user of an expected resolution time, transmitting commands over a network to modify operation of network equipment such as reroute network traffic from the network equipment experiencing the network issue to other network equipment, etc.

According to some embodiments, a method is provided. The method includes processing a knowledge structure, representing entities with nodes and relationships between entities as edges between the nodes, to create knowledge system entity embeddings, wherein the entities correspond to information within domain knowledge sources used by machine learning models to generate predictions; reducing a dimensionality of the knowledge system entity embeddings to create dimensional embeddings corresponding to latent representations of the entities and relations derived from the knowledge structure; processing the dimensional embeddings and the relationships from the knowledge structure using an optimal transport plan to generate feedback; and modifying the knowledge structure using the feedback for generating adaptive explainability information used to explain the predictions generated by the machine learning models.

According to some embodiments, the method includes generating the feedback to include context windows establishing new relationships between the entities within the knowledge structure.

According to some embodiments, the method includes utilizing the knowledge structure to identify information associated with a network issue; and executing a remedial action based upon the information.

According to some embodiments, the method includes evaluating the knowledge structure, modified using the feedback, to generate a first adaptive explainability description explaining why a machine learning model output a first prediction over a first context window.

According to some embodiments, the method includes evaluating the knowledge structure, modified using the feedback, to generate a second adaptive explainability description explaining why the machine learning model output a second prediction over a second context window, wherein the first prediction and the second prediction were generated at different times for a same input.

According to some embodiments, the method includes generating, utilizing the optimal transport plan, a new semantic relationship as the feedback based upon an entity modification being performed upon the knowledge structure.

According to some embodiments, the method includes iteratively generating feedback to provide adaptive explainability to explain why a machine learning model output different predictions over time for a same input.

According to some embodiments, the knowledge structure represents information from knowledge sources of different domains, wherein a domain relates to operation of a communication network.

According to some embodiments, the method includes computing an embedding for an entity, represented within the knowledge structure, based upon weights assigned to other entities, wherein a weight is a factor of a distance to the entity according to a Gaussian window function.

According to some embodiments, a system comprising one or more processors configured for executing the instructions to perform operations, is provided. The operations include processing a knowledge structure, representing entities with nodes and relationships between entities as edges between the nodes, to create knowledge system entity embeddings, wherein the entities correspond to information within domain knowledge sources used by machine learning models to generate predictions; reducing a dimensionality of the knowledge system entity embeddings to create dimensional embeddings corresponding to latent representations of the entities and relations derived from the knowledge structure; processing the dimensional embeddings and the relationships from the knowledge structure using an optimal transport plan to generate feedback; and modifying the knowledge structure using the feedback for generating adaptive explainability information used to explain the predictions generated by the machine learning models.

According to some embodiments, the operations further include generating weights for an entity with respect to other entities; and incorporating the weights into the optimal transport plan to guide a learning process of a variational autoencoder to reduce the dimensionality of the knowledge system entity embeddings.

According to some embodiments, the operations further include generating a cost matrix based upon a learned distribution generated by a variational autoencoder reducing the dimensionality of the knowledge system entity embeddings; and computing the optimal transport plan based on latent representations of the entities or relationships between the entities.

According to some embodiments, the operations further include computing an optimal transport loss with a window function based upon cost matrix values and a target distribution over the entities.

According to some embodiments, the operations further include defining a context window to capture neighboring entities of an entity that preserve a context of the entity; calculating a contextual embedding for the entity based upon the neighboring entities within the context window; utilizing a variational autoencoder to map the neighboring entities to latent representations of the neighboring entities in a same latent space as the entity.

According to some embodiments, the operations further include calculating a mean of the latent representations to obtain a contextual embedding for the entity.

According to some embodiments, the operations further include modifying an embedding of an entity to incorporate contextual information from the contextual embedding by adding the contextual embedding to an original embedding of the entity.

According to some embodiments, the operations further include modifying an embedding of an entity to incorporate contextual information from the contextual embedding by using a weighted combination of the contextual embedding and an original embedding of the entity.

According to some embodiments, a non-transitory computer-readable medium storing instructions that when executed facilitate performance of operations, is provided. The operations include processing a knowledge structure, representing entities with nodes and relationships between entities as edges between the nodes, to create knowledge system entity embeddings, wherein the entities corresponding to information within domain knowledge sources used by machine learning models to generate predictions; reducing a dimensionality of the knowledge system entity embeddings to create dimensional embeddings correspond to latent representations of the entities and relations derived from the knowledge structure; processing the dimensional embeddings and the relationships from the knowledge structure using an optimal transport plan to generate feedback; and modifying the knowledge structure using the feedback for generating adaptive explainability information used to explain the predictions generated by the machine learning models.

According to some embodiments, the operations further include utilizing the feedback to update an embedding for an entity based upon contextual relationships specified by the feedback while preserving an overall meaning and context of the entity.

According to some embodiments, the operations further include updating embeddings for the entities using the feedback to create new embeddings capturing aligned semantic relationships between entities within the knowledge structure.

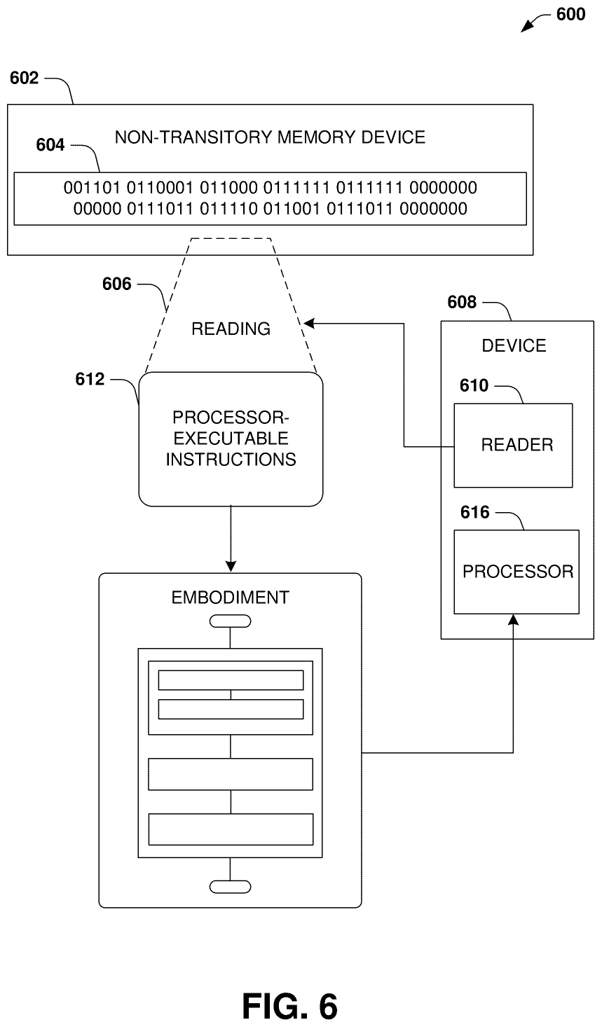

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 300 of FIG. 3, for example. In some embodiments, the processor-executable instructions 612 are configured to cause implementation of a system, such as at least some of the example system 100 of FIG. 1 and/or at least some of the example system 400 of FIG. 4.

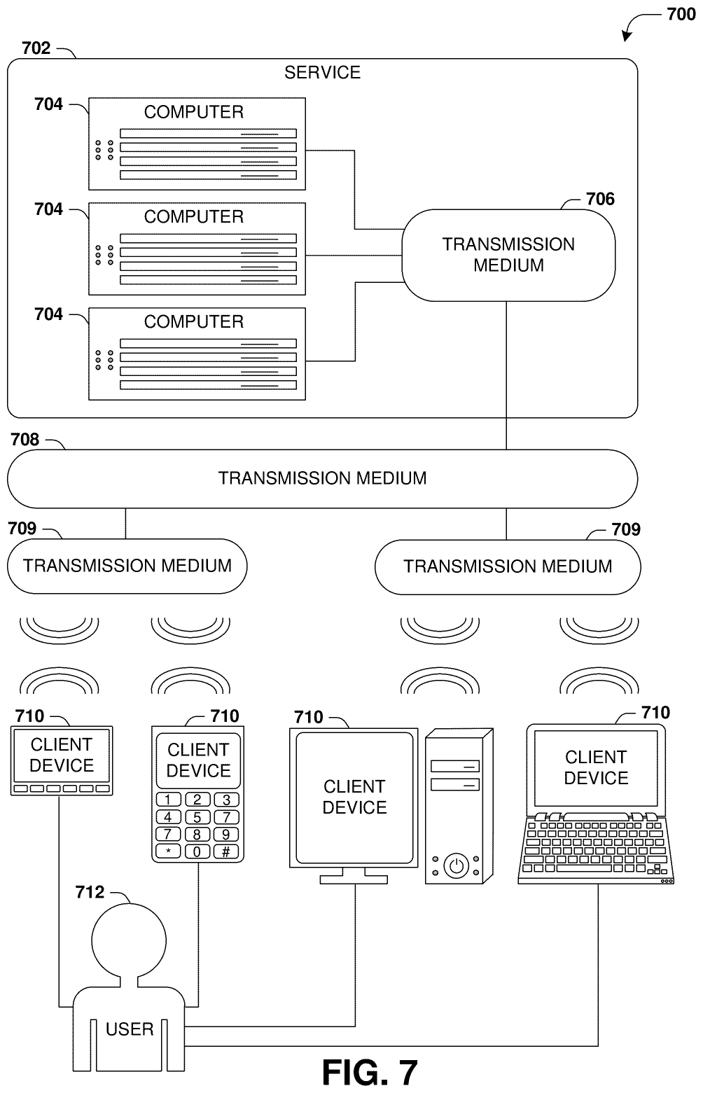

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

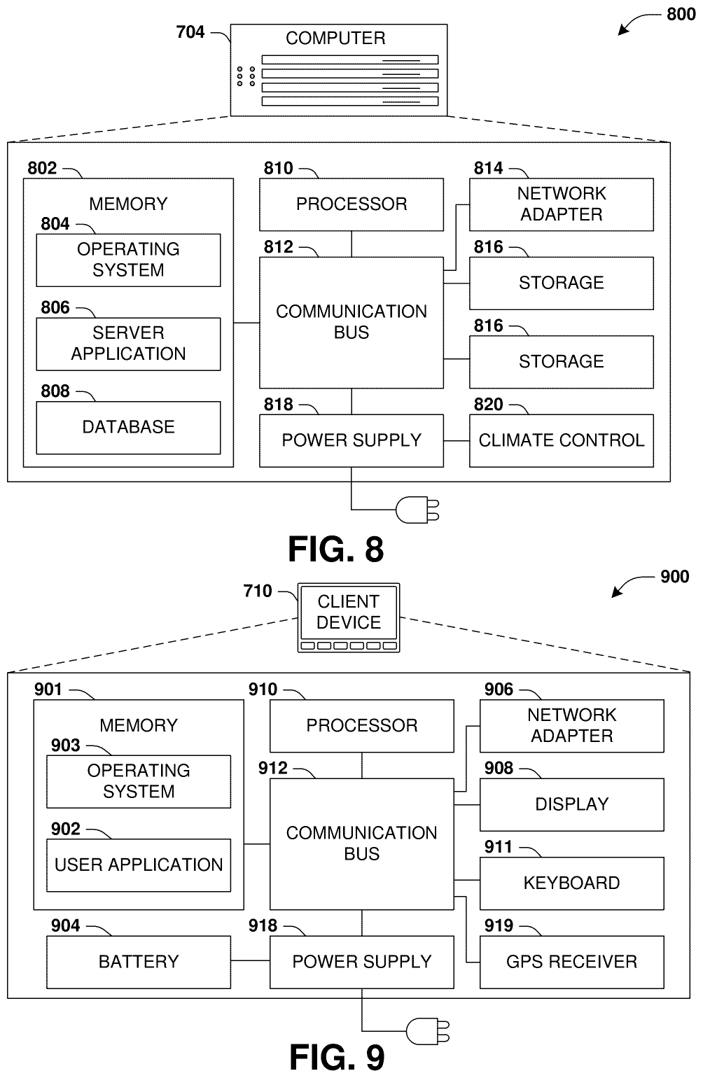

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
processing a knowledge structure, representing entities with nodes and relationships between entities as edges between the nodes, to create knowledge system entity embeddings, wherein the entities correspond to information within domain knowledge sources used by machine learning models to generate predictions;
reducing a dimensionality of the knowledge system entity embeddings to create dimensional embeddings corresponding to latent representations of the entities and relations derived from the knowledge structure;
processing the dimensional embeddings and the relationships from the knowledge structure using an optimal transport plan to generate feedback;
modifying the knowledge structure using the feedback; and
utilizing the knowledge structure to identify information associated with a network issue; and
executing a remedial action based upon the information.

2. The method of claim 1, comprising:
generating the feedback to include context windows establishing new relationships between the entities within the knowledge structure.

3. The method of claim 1, comprising:
modifying the knowledge structure using the feedback for generating adaptive explainability information used to explain the predictions generated by the machine learning models.

4. The method of claim 1, comprising:
evaluating the knowledge structure, modified using the feedback, to generate a first adaptive explainability description explaining why a machine learning model output a first prediction over a first context window.

5. The method of claim 4, comprising:
evaluating the knowledge structure, modified using the feedback, to generate a second adaptive explainability description explaining why the machine learning model output a second prediction over a second context window, wherein the first prediction and the second prediction were generated at different times for a same input.

6. The method of claim 1, comprising:
generating, utilizing the optimal transport plan, a new semantic relationship as the feedback based upon an entity modification being performed upon the knowledge structure.

7. The method of claim 1, comprising:
iteratively generating feedback to provide adaptive explainability to explain why a machine learning model output different predictions over time for a same input.

8. The method of claim 1, wherein the knowledge structure represents information from knowledge sources of different domains, wherein a domain relates to operation of a communication network.

9. The method of claim 1, comprising:
computing an embedding for an entity, represented within the knowledge structure, based upon weights assigned to other entities, wherein a weight is a factor of a distance to the entity according to a Gaussian window function.

10. A system, comprising:
one or more processors configured for executing instructions to perform operations comprising:
processing a knowledge structure, representing entities with nodes and relationships between entities as edges between the nodes, to create knowledge system entity embeddings, wherein the entities correspond to information within domain knowledge sources used by machine learning models to generate predictions;
reducing a dimensionality of the knowledge system entity embeddings to create dimensional embeddings corresponding to latent representations of the entities and relations derived from the knowledge structure;
processing the dimensional embeddings and the relationships from the knowledge structure using an optimal transport plan to generate feedback; and
modifying the knowledge structure using the feedback for generating adaptive explainability information used to explain the predictions generated by the machine learning models.

11. The system of claim 10, wherein the operations further comprise:
generating weights for an entity with respect to other entities; and
incorporating the weights into the optimal transport plan to guide a learning process of a variational autoencoder to reduce the dimensionality of the knowledge system entity embeddings.

12. The system of claim 10, wherein the operations further comprise:
generating a cost matrix based upon a learned distribution generated by a variational autoencoder reducing the dimensionality of the knowledge system entity embeddings; and
computing the optimal transport plan based on latent representations of the entities or relationships between the entities.

13. The system of claim 10, wherein the operations further comprise:
computing an optimal transport loss with a window function based upon cost matrix values and a target distribution over the entities.

14. The system of claim 10, wherein the operations further comprise:
defining a context window to capture neighboring entities of an entity that preserve a context of the entity;
calculating a contextual embedding for the entity based upon the neighboring entities within the context window;
utilizing a variational autoencoder to map the neighboring entities to latent representations of the neighboring entities in a same latent space as the entity.

15. The system of claim 14, wherein the operations further comprise:
calculating a mean of the latent representations to obtain a contextual embedding for the entity.

16. The system of claim 15, wherein the operations further comprise:
modifying an embedding of an entity to incorporate contextual information from the contextual embedding by adding the contextual embedding to an original embedding of the entity.

17. The system of claim 15, wherein the operations further comprise:
modifying an embedding of an entity to incorporate contextual information from the contextual embedding by using a weighted combination of the contextual embedding and an original embedding of the entity.

18. A non-transitory computer-readable medium storing instructions that when executed facilitate performance of operations comprising:
processing a knowledge structure, representing entities with nodes and relationships between entities as edges between the nodes, to create knowledge system entity embeddings, wherein the entities corresponding to information within domain knowledge sources used by machine learning models to generate predictions;
reducing a dimensionality of the knowledge system entity embeddings to create dimensional embeddings correspond to latent representations of the entities and relations derived from the knowledge structure;
processing the dimensional embeddings and the relationships from the knowledge structure using an optimal transport plan to generate feedback; and
modifying the knowledge structure using the feedback for generating adaptive explainability information used to explain the predictions generated by the machine learning models.

19. The non-transitory computer-readable medium of claim 18, wherein the operations further comprise:
utilizing the feedback to update an embedding for an entity based upon contextual relationships specified by the feedback while preserving an overall meaning and context of the entity.

20. The non-transitory computer-readable medium of claim 18, wherein the operations further comprise:
updating embeddings for the entities using the feedback to create new embeddings capturing aligned semantic relationships between entities within the knowledge structure.
